(19) United States
(12) Patent Application Publication
(10) Pub. No.: US 2018/0252542 A1
(43) Pub. Date: Sep. 6, 2018

(54) MONITORING AND MANAGING TASK COMPLETION BY AN ON-DEMAND SERVICE PROVIDER

(71) Applicant: Picup Technologies (Pty) Ltd, Cape Town (ZA)

(72) Inventors: Antonio Italo Bruni, Claremont (ZA); Justin Johael Asher, Cape Town (ZA); Michele Marrai, Cape Town (ZA); Ashley Arendse, Cape Town (ZA)

(21) Appl. No.: 15/911,774

(22) Filed: Mar. 5, 2018

(30) Foreign Application Priority Data
Mar. 6, 2017 (ZA) 2017/01595

(51) Int. Cl. G01C 21/34; G01C 21/36; H04W 4/02

(52) U.S. Cl. CPC G01C 21/3453; H04W 4/025; G01C 21/343; G01C 21/3617

(57) ABSTRACT

A system and method for monitoring and managing task completion by an on-demand service provider is described. In a method, geographical location data representing a sequence of recorded geographical locations is received. Each recorded geographical location represents a location at which a service provider inputs a task completion status into the mobile communication device in association with a task and associated predetermined geographical location. An estimated route is obtained using the sequence of recorded geographical locations. The estimated route represents a probable route having been traversed by the service provider in attempting to complete the tasks. A suggested optimal route is accessed. The suggested optimal route is based on the predetermined geographical locations and representing an optimal route for completing the tasks in an optimal sequence. An operational distance is determined based on a total distance of the estimated route and on a total distance of the suggested optimal route.

### CROSS-REFERENCE TO RELATED APPLICATIONS

This application claims priority from South African provisional patent application number 2017/01595 filed on 6 Mar. 2017, which is incorporated by reference herein.

### FIELD OF THE INVENTION

This invention relates to a system and method for monitoring and managing task completion by an on-demand service provider in which the service provider completes a plurality of tasks at respective geographical locations.

### BACKGROUND TO THE INVENTION

There is currently a trend for courier services to be provided by independent couriers “on-demand”. These independent couriers, who may simply be referred to as “service providers”, may use their own vehicles. Each may have a personal mobile communication device which, using an appropriate software application, allows them to accept a task list which may specify a number of deliveries and associated geographical locations at which the deliveries are to be made.

The service provider may then be required to physically visit each geographical location in his or her task list so as to complete the associated task (i.e. the delivery). As these service providers are on-demand based, it would be advantageous to remunerate them based on the work they actually do. A daily rate, for example, would not suffice.

Existing technological platforms may enable remuneration based on the actual distance travelled by the service provider, for example by using GPS or odometer-based tracking to monitor the service provider's movements as he or she completes respective tasks. However, such technology at present fails to distinguish between distance travelled pursuant to completion of a task and distance travelled for a private attendance. For example, while traveling to a particular geographical location in order to complete a task, the service provider may decide temporarily to veer of course in order to pursue a personal errand or the like.

It may further be difficult to monitor the service provider's movements on a continual basis in order to track actual distance travelled. Tracking actual distance travelled by the service provider may therefore be inadequate.

Adding to such difficulties is the problem of “failed attempts” in which after travelling to the appropriate geographical location the service provider finds that he or she is unable to complete the task. Without tracking the movements of the service provider on a continual basis, there is currently no appropriate technical solution by way of which failed attempts can be accounted for in the service provider's remuneration. Failed attempts may pose further logistical difficulties as the relevant parcel may have to be returned to the originating location and, in commercial scenarios, may have to be processed and accounted for before being dispatched again.

There is accordingly a need for a technological platform that enables monitoring and managing task completion by an on-demand service provider that alleviates these and/or other problems.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method comprising: receiving geographical location data from a mobile communication device associated with a service provider, the geographical location data representing a sequence of recorded geographical locations, each of the recorded geographical locations representing a location at which a service provider inputs a task completion status into the mobile communication device in association with a task and associated predetermined geographical location; obtaining an estimated route using the sequence of recorded geographical locations, the estimated route representing a probable route having been traversed by the service provider in attempting to complete the tasks; accessing a suggested optimal route, the suggested optimal route being based on the predetermined geographical locations and representing an optimal route for completing the tasks in an optimal sequence; and, determining an operational distance based on a total distance of the estimated route and on a total distance of the suggested optimal route.

Further features provide for the method to include: providing an application to a service provider for installation on the mobile communication device; storing the geographical location data in a database in association with a task list; and outputting the operational distance.

Further features provide for: the optimal route and estimated route to be different; for the optimal route to be based on an optimal sequence of the predetermined geographical locations; for the estimated route to be based on the actual sequence of the recorded geographical locations; and for the actual sequence of the recorded geographical locations be the sequence in time in which the recorded geographical locations are recorded.

Still further features provide for each recorded geographical location to be recorded by a geographical location element of the mobile communication device associated with the service provider; for each recorded geographical location to be recorded responsive to the service provider inputting into the mobile communication device the task completion status, being one of a success or failure status in respect of an attempted completion of the task; and for the geographical location data to include, for each recorded geographical location, one or more of: the task completion status, a task identifier associated with the task and a timestamp at which the geographical location is recorded.

A further feature provides for determining the operational distance based on the estimated and suggested optimal route distances to include determining an average of the estimated and suggested optimal route distances.

A still further feature provides for the method to include determining a remuneration amount for completing the plurality of tasks based on the operational distance and the status associated with each recorded geographical location.

A yet further feature provides for determining the remuneration amount to include determining the sum of the operational distance multiplied by a distance-based amount and the number of success statuses multiplied by a success-based amount.

Each task may include delivery of one or more parcels to a client by the service provider.

Further features provide for the method to include determining a distance between each recorded geographical location associated with a failure status and the corresponding predetermined geographical location and, if the distance is greater than a predetermined threshold, rejecting the recorded geographical location and associated status; for rejecting the recorded geographical location and associated status to exclude the recorded geographical location from the estimated route.

A still further feature provides for the method to include: receiving a notification from a mobile communication device associated with a client in respect of whom a task relates, the notification indicating that the client is not in a position to facilitate completion of the task at the predetermined geographical location associated therewith; receiving a current geographical location from the client mobile communication device; determining whether the current geographical location is within a predetermined range of the predetermined geographical location; and, if the current geographical location is within the predetermined range of the predetermined geographical location, directing the service provider to the current geographical location.

A yet further feature provides for directing the service provider to the current geographical location to include: polling the client mobile communication device for an updated current geographical location; receiving an updated current geographical location from the client mobile communication device; and, forwarding the updated current geographical location to the service provider mobile communication device for use in directing the service provider to the client mobile communication device.

In accordance with a further aspect of the invention there is provided a system comprising: a processor and a memory configured to provide computer program instructions to the processor to execute functions of components; a geographical location data receiving component for receiving geographical location data from a mobile communication device associated with a service provider, the geographical location data representing a sequence of recorded geographical locations, each of the recorded geographical locations representing a location at which a service provider inputs a task completion status into the mobile communication device in association with a task and associated predetermined geographical location; an estimated route obtaining component for obtaining an estimated route using the sequence of recorded geographical locations, the estimated route representing a probable route having been traversed by the service provider in attempting to complete the tasks in sequence; a suggested optimal route obtaining component for accessing a suggested optimal route, the suggested optimal route being based on the predetermined geographical locations and representing an optimal route for completing the tasks in an optimal sequence; and, an operational distance determining component for determining an operational distance based on a total distance of the estimated route and on a total distance of the suggested optimal route.

Further features provide for: the optimal route and estimated route to be different; for the optimal route to be based on an optimal sequence of the predetermined geographical locations; and, for the estimated route to be based on the actual sequence of the recorded geographical locations.

Still further features provide for each recorded geographical location to be recorded by a geographical location element of the mobile communication device associated with the service provider; for each recorded geographical location to be recorded responsive to the service provider inputting into the mobile communication device the task completion status, being one of a success or failure status in respect of an attempted completion of the task; and for the geographical location data to include, for each recorded geographical location, one or more of: the task completion status, a task identifier associated with the task and a timestamp at which the geographical location is recorded.

A further feature provides for the operational distance determining component to an average of the estimated and suggested optimal route distances.

A still further feature provides for the system to include a remuneration amount determining component for determining a remuneration amount for completing the plurality of tasks based on the operational distance and the status associated with each recorded geographical location.

A yet further feature provides for the remuneration amount determining component to determine the sum of the operational distance multiplied by a distance-based amount and the number of success statuses multiplied by a success-based amount.

Each task may include delivery of one or more parcels to a client by the service provider.

Further features provide for the system to include a predetermined and recorded distance comparing component for determining a distance between each recorded geographical location associated with a failure status and the corresponding predetermined geographical location and a rejecting component for, if the distance is greater than a predetermined threshold, rejecting the recorded geographical location and associated status; for the rejecting component to exclude the recorded geographical location from the estimated route.

A still further feature provides for the system to include: a notification receiving component for receiving a notification from a mobile communication device associated with a client in respect of whom a task relates, the notification indicating that the client is not in a position to facilitate completion of the task at the predetermined geographical location associated therewith; a current geographical location receiving component for receiving a current geographical location from the client mobile communication device; a range determining component for determining whether the current geographical location is within a predetermined range of the predetermined geographical location; and, a directing component for, if the current geographical location is within the predetermined range of the predetermined geographical location, directing the service provider to the current geographical location.

A still further feature provides for the directing component to include: a location polling component for polling the client mobile communication device for an updated current geographical location; an updated current geographical location receiving component for receiving an updated current geographical location from the client mobile communication device; and, a forwarding component for forwarding the updated current geographical location to the service provider mobile communication device for use in directing the service provider to the client mobile communication device.

In accordance with a further aspect of the invention there is provided a computer program product comprising a computer-readable medium having stored computer-readable program code for performing the steps of: receiving geographical location data from a mobile communication device associated with a service provider, the geographical location data representing a sequence of recorded geographical locations, each of the recorded geographical locations representing a location at which a service provider inputs a task completion status into the mobile communication device in association with a task and associated predetermined geographical location; obtaining an estimated route using the sequence of recorded geographical locations, the estimated route representing a probable route having been traversed by the service provider in attempting to complete the tasks; accessing a suggested optimal route, the suggested optimal route being based on the predetermined geographical locations and representing an optimal route for completing the tasks in an optimal sequence; and, determining an operational distance based on a total distance of the estimated route and on a total distance of the suggested optimal route.

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1 is a schematic diagram which illustrates an exemplary system for monitoring and managing task completion by an on-demand service provider;

FIG. 2 is a swim-lane flow diagram which illustrates an exemplary method for monitoring and managing task completion by an on-demand service provider;

FIG. 3 is a swim-lane flow diagram which illustrates an exemplary tracking facility method according to aspects of the present disclosure;

FIG. 4 is a block diagram which illustrates components of an exemplary system for monitoring and managing task completion by an on-demand service provider; and,

FIG. 5 illustrates an example of a computing device in which various aspects of the disclosure may be implemented.

### DETAILED DESCRIPTION WITH REFERENCE TO THE DRAWINGS

A system and method for monitoring and managing task completion by an on-demand service provider is described. The service provider agrees to complete a plurality of tasks at respective geographical locations and the system and method monitor and manage the service provider's completion of the tasks. Aspects of this disclosure may enable a service provider to be remunerated based on actual mileage driven whilst taking into account a pre-optimized route plan and total number of invoices delivered.

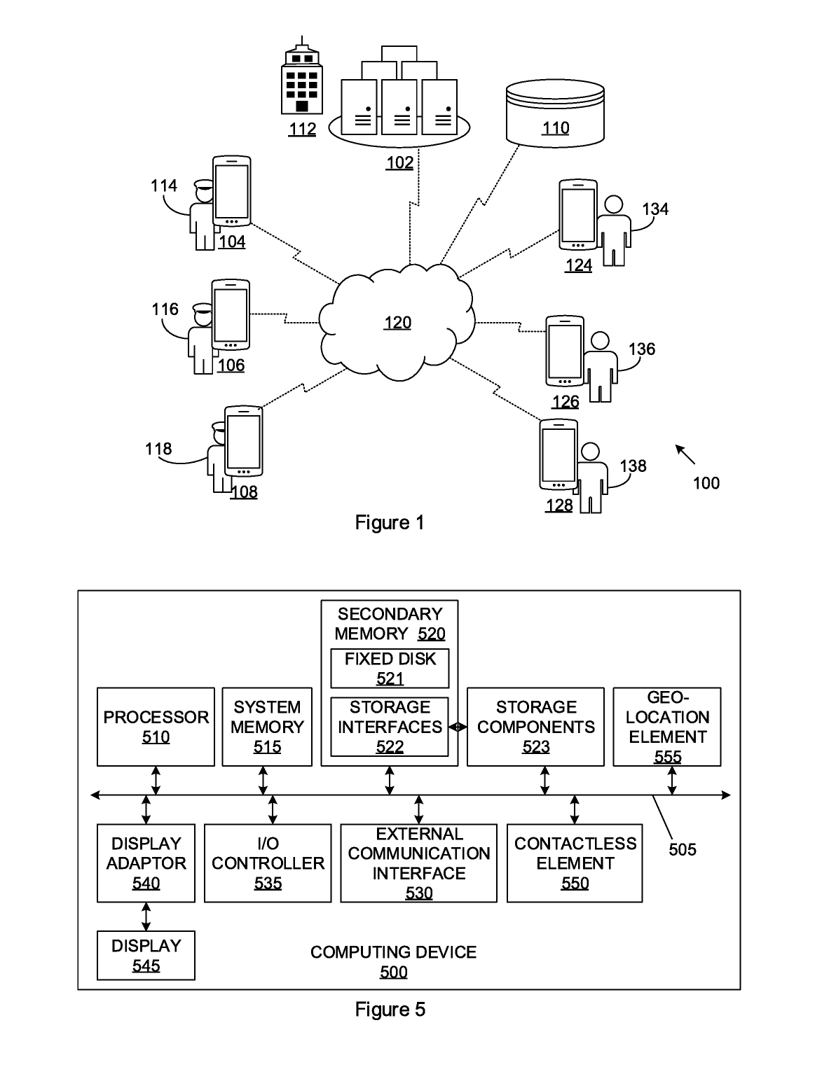

FIG. 1 is a schematic diagram which illustrates an exemplary system (100) for monitoring and managing task completion by an on-demand service provider. The system (100) includes a remotely accessible server computer (102) associated with an entity (112) and which may be in communication with a plurality of mobile communication devices (104, 106, 108), each of which being associated with a respective service provider (114, 116, 118), via an appropriate communication network (120). The system (100) may also include a plurality of mobile communication devices (124, 126, 128) associated with respective clients (134, 136, 138) and which may also be configured for communication via the communication network (120).

In a specific implementation, the entity (112) may provide an on-demand courier or delivery service in which the service providers (114, 116, 118) are independent third parties who accept tasks from the entity (112). The tasks may involve delivery by the appropriate service provider (114, 116, 118) of one or more parcels to the appropriate client (134, 136, 138). In some implementations, the parcels may be collected by the service providers (114, 116, 118) from suppliers for delivery to the clients while in other implementations, a client-to-client on-demand delivery service may be provided. The tasks may be offered to the service providers (114, 116, 118) in the form of a task list which may be sent to the mobile communication devices of the service providers. The tasks in the task list may be presented in an optimal sequence (described in greater detail below) for acceptance or rejection by the service providers.

It should however be appreciated that the described system and method may be implemented in or applicable to any appropriate on-demand service in which task completion monitoring and management across distributed geographical locations may be required.

The remotely accessible server (102) may have access to a database (110) in which records may be stored and from which such records may be accessed, updated or deleted. There may for example be a record relating to each of a plurality of task lists, service providers (114, 116, 118) and clients (134, 136, 138). In some implementations, a task list record may include a task list identifier and a plurality of tasks. Each task may be associated with one or more of a task identifier, a task description, particulars of a client associated with the task (or a pointer to an associated client record, such as a client identifier), a predetermined geographical location (corresponding to a location at which the associated task is to be completed or performed), and a recorded geographical location (having been obtained by a service provider device in response to the service provider purporting to have attempted to complete or perform the task). Each service provider record may include particulars relating to the service provider, a service provider identifier, a service provider communication address (e.g. for sending messages, notifications, data, etc. to a service provider communication device) and the like. The service provider record may also include a task list identifier of any task lists which may be associated with the service provider (e.g. by virtue of the service provider having accepted the task list).

The service provider mobile communication devices (104, 106, 108) may be any appropriate portable computing devices which are capable of communicating via the communication network (120). The service provider devices (104, 106, 108) may have an appropriate service provider software application via which the service providers (114, 116, 118) can interact with the remotely accessible server (102). The service provider devices (104, 106, 108) may also be configured for displaying tasks to their associated service providers and may provide a navigation facility should the service provider require navigation to a predetermined geographical location associated with the task.

The client mobile communication devices (124, 126, 128) may similarly be any appropriate portable computing devices which are capable of communicating via the communication network (120). The client devices (124, 126, 128) may be configured to provide their associated clients (134, 136, 138) with notifications of a scheduled or an impending arrival of a service provider for task completion or performance. As will be explained in greater detail below, the client devices (124, 126, 128) may also be configured for updating the remotely accessible server as to a current geographical location of the client device (124, 126, 128).

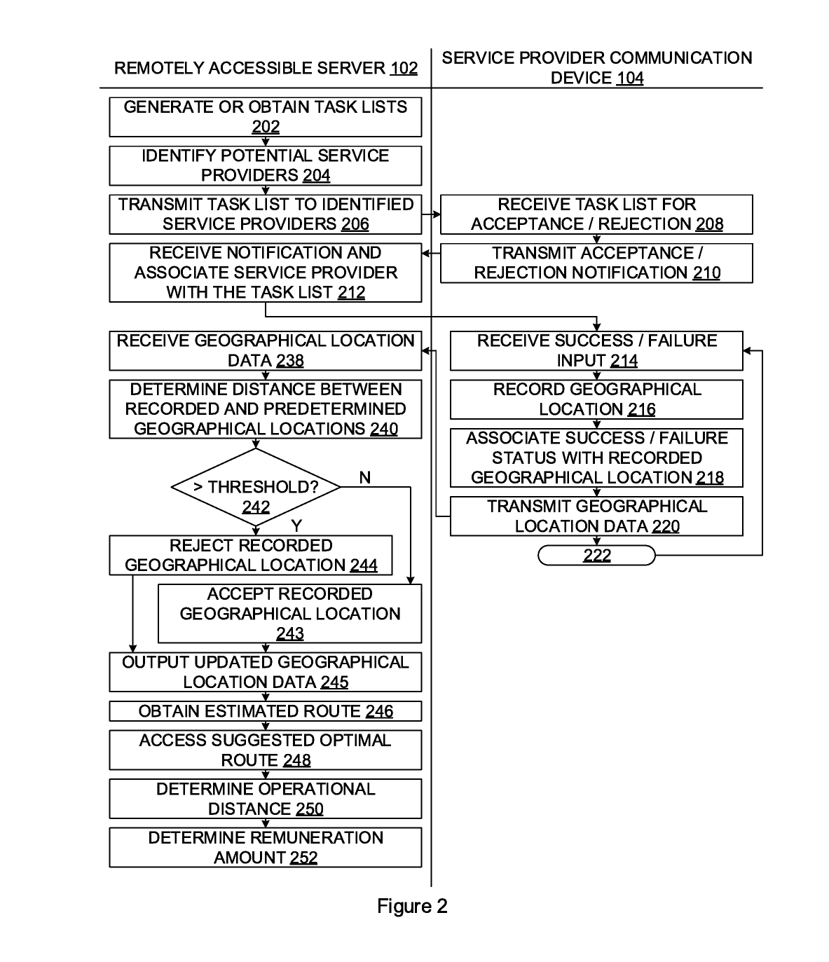

The system (100) may implement a method for monitoring and managing task completion by an on-demand service provider. FIG. 2 is a swim-lane flow diagram which illustrates an exemplary method for monitoring and managing task completion by an on-demand service provider in which respective swim-lanes delineate functions, steps, operations or procedures that may be performed by the respective entities or devices.

The method is described with reference to an exemplary e-commerce scenario in which a number of clients (134, 136, 138) have ordered parcels from one or more e-commerce merchants. The e-commerce merchants may request the entity (112) to facilitate delivery of the parcels. It should of course be appreciated that the described method may be extended to any suitable scenario in which on-demand task completion across distributed geographical locations is required to be monitored and/or managed.

The remotely accessible server (102) may generate or obtain (202) a plurality of task lists. Each task list may be for a specific day and may include a plurality of tasks. Each task may be associated with a task identifier and a predetermined geographical location at which the task is to be completed or performed. The task lists may be generated such that the predetermined geographical locations associated with each of the respective tasks included in a given task list have a predetermined geographical relationship. For example, the predetermined geographical locations may fall within specific postal or zip codes, may all be within a predetermined distance of one another, may all be linked by major transportation routes, etc. Generating the task list may include identifying tasks being associated with respective predetermined geographical locations which satisfy a predetermined geographical relationship. In this exemplary scenario, each task list may include a number of tasks being parcel deliveries and the predetermined geographical locations may be the shipping address (or geographical coordinates corresponding to the shipping address, etc.) of the clients having ordered the respective parcels.

The predetermined geographical locations included in each task list may be arranged in a sequence and generating or obtaining (202) the plurality of task lists may include, for each task list, obtaining a suggested optimal route. The suggested optimal route may be a route which the service provider (114) should travel in order to complete each of the tasks in the shortest possible time, by travelling the shortest possible distance or in another optimal manner. The sequence in which the tasks in each task list is arranged may be an optimal sequence, which may correspond to the suggested optimal route.

The remotely accessible server (102) may, for each task list, identify (204) potential service providers (e.g. 114, 116) who are best suited to completing or performing the associated tasks. For example, the service providers (114, 116, 118) may be associated with preferred postal or zip codes or particular geographical locations and the remotely accessible server (102) may be configured to match task lists to suitable service providers on this basis. Service providers may be required to be online (e.g. having a service provider software application open on their mobile communication device) to be identified as being suitable.

The remotely accessible server (102) may transmit (206) an offer notification to the communication devices (104, 106) of the identified service providers (114, 116). The offer notification may include the task list and optionally associated information and may be configured to prompt the service provider (114, 116) for his or her acceptance or rejection of the task list. In some implementations, an offer notification may be transmitted serially from one (e.g. starting with a preferred) service provider to another until the task list is accepted. In other implementations, the offer notification may be transmitted to a plurality of service providers and may be available for acceptance on a first-come first-served basis.

The mobile communication devices (104, 106) of the identified service providers (114, 116) may receive (208) the task list from the remotely accessible server (102) for acceptance or rejection. The mobile communication devices (104, 106) may prompt the respective service providers associated therewith for their acceptance or rejection of the task list. This may include displaying particulars of the task list, for example the number of tasks, the estimated total distance, timing constraints (i.e. a deadline by which the task list must be completed), etc. The mobile communication devices (104, 106) of the identified service providers (114, 116) may receive user input (e.g. in in the form of activation of an ‘accept’ or ‘reject’ graphical component) from their respective service providers indicating their acceptance or rejection, as the case may be, of the task list and may transmit (210) an acceptance or rejection notification to the remotely accessible server (102).

The remotely accessible server (102) may receive (212) an acceptance notification from a mobile communication device of a service provider (e.g. 114) and may associate the service provider (114) having accepted the task list with the task list.

Having accepted the task list, the service provider (114) may then commence travelling to each of the predetermined geographical locations included in the task list. As mentioned, the geographical locations may be ordered in an optimal sequence which, if followed by the service provider (114), could be the optimal way in which the task list could be completed.

It should however be appreciated that for a number of reasons the service provider may elect not to follow the optimal sequence. The service provider (114) may for example have a good knowledge of the geographical area in which he or she operates, and may consider another sequence to be preferable. In some cases, the service provider may be contacted by the entity or supplier instructing the service provider (114) not to complete a particular task (e.g. in the case of a delivery, because the client is not at home). Further, the service provider (114) may be an independent contractor and/or self-employed and may decide to make a personal detour (e.g. to buy lunch, visit a friend, etc.) while completing the task list, thus deviating from the optimal route. In some cases, the service provider may have to revisit some predetermined geographical locations multiple times before being able to successfully complete the task.

As such, the suggested optimal sequence may not be followed by the service provider (114). Upon arriving at a predetermined geographical location associated with a task and task identifier, the service provider (114) may attempt to complete or perform the task. The service provider may successfully complete the task or may fail to do so (e.g. in the case of a delivery, the client may not be home, etc.). In attempting to complete or perform the task, the service provider (114) may input a ‘success’ or ‘failure’ indication into the service provider mobile communication device (104), as may be appropriate.

The mobile communication device (104) may receive (214) the task completion status input and, responsive to which, may record (216) the geographical location of the mobile communication device (104). Recording (216) the geographical location of the mobile communication device may obtain real-time geographical information from a geographical location element embedded within the mobile communication device. Real-time geographical information may include, for example, GPS coordinates corresponding to the geographical position of the mobile communication device shortly after the point in time at which the user input is received. It should be appreciated that ordinarily, the recorded geographical location and the corresponding predetermined geographical location will, taking into account measurement inaccuracies, be very similar. However, in some cases, in particular in the case of a failed attempt at completing a task, the recorded geographical location and the predetermined geographical location may not be the same (and may be out by hundreds or even thousands of meters or yards). This may for example be because the service provider is unable to access a geographical area within which the predetermined geographical location falls (e.g. by virtue of a security check point) or because the service provider is dishonestly purporting to have attempted to complete the task.

Depending on the input, the mobile communication device (104) may associate (218) a success or failure status, as the case may be, with one or more of the task identifier, the recorded geographical location and a timestamp. The mobile communication device (104) may transmit (220) geographical location data including the status, task identifier, recorded geographical location and timestamp to the remotely accessible server (102). In some cases, the mobile communication device (104) may transmit the status, task identifier, recorded geographical location and timestamp to the remotely accessible server in real-time (e.g. in response to associating the data) such that the remotely accessible server (102) receives the geographical location data through the course of the day as the service provider visits each of the predetermined geographical locations, etc., or alternatively as a batch together with other statuses and associated data, for example once the task list has been completed.

In either event, the geographical location data is updated and ultimately may include or represent a sequence of recorded geographical locations. Each of the recorded geographical locations may be associated with one or more of a status, task identifier and timestamp. Consequently, each of the recorded geographical locations may correspond to a predetermined geographical location (e.g. by way of a common task identifier) and may represent a physical location at which the service provider purports to have attempted to complete an associated task.

It may be noted that in the described implementation, the service provider's movements are not tracked by the remotely accessible server computer, for example on a second-by-second or minute-by-minute basis. In addition, the mobile communication device of the service provider may not need to track its geographical location on an ongoing (e.g. second-by-second, minute-by-minute, etc.) basis. This may result in improved battery life of the service provider device and may also reduce cellular or mobile data costs which may be incurred for any data transmitted between the service provider device (104) and the remotely accessible server (102). It may also provide the service provider (104) with a degree of autonomy, knowing that he or she can intersperse task completion with personal errands without being tracked by the remotely accessible server (102). There may accordingly be data privacy benefits. Network traffic experienced by the remotely accessible server (102), especially when the number of service providers is large, may also be reduced.

The service provider (114) may the travel to a next predetermined geographical location and attempt to complete the associated task thereat. Receiving (214) an input of the appropriate status ('success' or ‘failure’), recording (216) the geographical location and associating (218) the status with one or more of the task identifier, the recorded geographical location and a timestamp may then be repeated (222) for each of the predetermined geographical locations which the service provider (114) purports to have visited.

At any point, the service provider (114) may request re-optimization of the sequence of tasks in the task list. This re-optimization may take into account the service provider's geographical location at the time at which the re-optimization is requested and may of course disregard tasks that have already been successfully completed. Requesting re-optimization may include the service provider communication device (104) transmitting a re-optimization request to the remotely accessible server (102). The remotely accessible server (102) may receive the request, perform a re-optimization sequence on the remaining predetermined geographical locations and transmit a re-optimized task list to the service provider communication device (104).

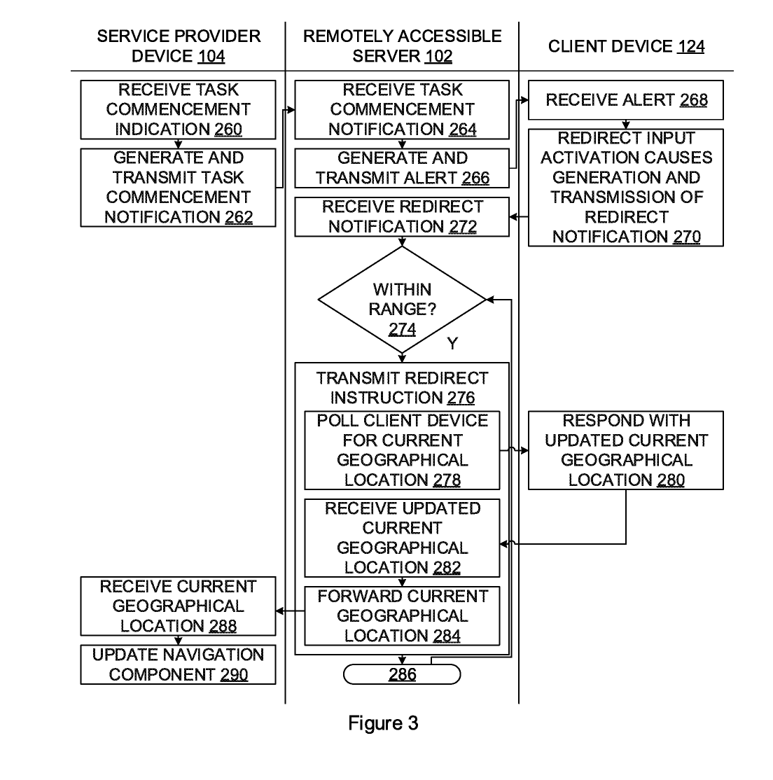

It is also possible that some clients, upon being notified that the service provider (114) is en route for the completion or performance of a task, may realize that they are not currently at the predetermined geographical location which is associated with the relevant task. Aspects of this disclosure may provide a tracking facility by way of which the client can allow the service provider to navigate to the client's current location instead of the predetermined location. A tracking facility method is described in greater detail in FIG. 3.

The remotely accessible server (102) may receive (238) the geographical location data from the mobile communication device (104). As mentioned, the geographical location data may be received as a single batch of recorded geographical locations and associated data (e.g. at the end of each day, upon completion of a task list, etc.) or may be received over a course of time, for example as the service provider attempts to complete each of the tasks in the task list. Each recorded geographical location may represent a geographical location at which the service provider inputs a task completion status (e.g. success or failure) into the mobile communication device in association with a task associated with the predetermined threshold. The geographical location data may represent a sequence of recorded geographical locations at which the service provider (114) purports to have attempted to complete associated tasks. Each recorded geographical location may have been recorded by the mobile communication device (104) associated with the service provider (114) responsive to the service provider inputting into the mobile communication device one of a success or failure status in respect of the attempted completion of the task. A mechanism for determining whether or not the service provider actually attempted to complete the task may thus be provided.

The remotely accessible server (102) may determine (240) a distance between each recorded geographical location associated with a failure status and the associated predetermined geographical location. If (242) the comparison yields a distance that is greater than a predetermined threshold, the remotely accessible server (102) may reject (244) the relevant recorded geographical location and associated status. Otherwise, the recorded geographical location may be accepted (243). Rejecting (244) the recorded geographical location and associated status may exclude the recorded geographical location from an estimated route (described below). In some cases, rejecting (244) the recorded geographical location and associated status may require outputting (245) updated geographical location data which includes the accepted recorded geographical locations and which does not include the rejected recorded geographical locations and associated statues. This may ensure that the service provider legitimately attempts to complete the task by ensuring that the service provider travels to the predetermined geographical location, within the lenience allowed by the predetermined threshold (which may, for example be between 100 and 800 meters or yards). In some implementations, if the comparison yields a distance which is greater than the predetermined threshold, the remotely accessible server (102) may flag the event for investigation and resolution.

The remotely accessible server (102) may obtain (246) an estimated route using the sequence of recorded geographical locations. The estimated route may be based on the actual sequence of the recorded geographical locations (e.g. as opposed to an optimal sequence). The actual sequence of the recorded geographical locations may be the sequence in time in which the recorded geographical locations are recorded. I.e. the sequence may be arranged based on time stamps associated with the recorded geographical locations in order to determine the actual sequence of recorded geographical locations.

In some implementations, the estimated route may be obtained using updated geographical location data which does not include rejected recorded geographical locations and associated statues. The estimated route may represent a probable route which the service provider (114) may have traversed in attempting to complete the plurality of tasks in the particular sequence. Obtaining (246) the estimated route may use a third-party service to determine an optimal or expected route based on the recorded geographical locations and the sequence in which they were recorded (and hence visited). In some implementations, the estimated route excludes recorded geographical locations which were not within the predetermined threshold of associated predetermined geographical locations. As will be explained below, the effect of this may be that the service provider (114) is not compensated in cases where the service provider purports to have completed the task at a geographical location which is too remote from the predetermined geographical location (being the geographical location at which the task was required to have been completed).

The remotely accessible server (102) may then access (248) the suggested optimal route, which may represent an optimal route for traversal by the service provider (114) in order to complete the plurality of tasks in an optimal sequence. It should be appreciated that the optimal route and estimated route may be (but are not necessarily) different. The optimal route may be based on an optimal sequence of the predetermined geographical locations (e.g. the optimal sequence determined when compiling (202) the task list).

The remotely accessible server (102) may determine (250) an operational distance based on a total distance of the estimated route and on a total distance of the suggested optimal route. The operational distance may be a remunerable distance in that it represents a distance on which the service provider's remuneration will be based. The suggested optimal route may be a pre-computed optimal route which may have been generated or obtained prior to associating the task list with the relevant service provider. Determining (250) the operational distance based on the estimated and suggested optimal route distances may include determining an average of the estimated and suggested optimal route distances (e.g. by adding the two distances together and dividing by two).

The operational distance may thus take into account detours which may have been made by the service provider on account of legitimate failed attempts at completing tasks. The operational distance may however also incentivize the service provider to follow to a pre-computed optimal route such that task completion is performed optimally. Further, the operational distance may disregard detours which may have been made by the service provider for personal reasons (i.e. not in pursuance of task completion). Determining (250) the operational distance may include outputting the operational distance for controlling or providing feedback to an administrative component.

The remotely accessible server (102) may determine (252) a remuneration amount payable to the service provider (114) for completing the plurality of tasks. The remuneration amount may be based on the operational distance and the status (i.e. success or failure) associated with each recorded geographical location. In some implementations, determining (252) the remuneration amount (RA) may include determining the sum of the operational distance (RD) multiplied by a distance-based amount (DBA), e.g. dollars per kilometer (or mile), and the number of success statuses (NSS) multiplied by a success-based amount (SBA), e.g. dollars per task completed successfully. For example:

RA=RD*DBA+NSS*SBA

The remuneration amount may consequently take into account the operational distance travelled by the service provider (114) and the number of tasks which the service provider (114) completes successfully. The number of times the service provider fails to complete a task (e.g. because the client is not at the predetermined geographical location, etc.) may not be accounted for. However, if the service provider ultimately completes the task, the distance travelled by the service provider in attempting, but failing, to complete the task may be accounted for (based on the above described operational distance model). By accounting for the number of tasks successfully completed by the service provider, the service provider may be compensated for the number of parcels he or she carries in his or her vehicle and in turn for any additional wear and tear that may be associated therewith.

FIG. 3 is a swim-lane flow diagram which illustrates an exemplary tracking facility method. Respective swim-lanes delineate functions, steps, operations or procedures that may be performed by the respective entities or devices.

At some point, while a service provider (134) is busy with a task list and is, for example, en route to a client (134) for completion or performance of a task, the client (134) may realize that he or she is not currently at the predetermined geographical location (e.g. shipping or delivery address provided at the time of ordering the parcel) which is associated with the relevant task.

For example, when the service provider (134) commences a task, he or she may input a task commencement indication into the service provider communication device (104). The service provider communication device (104) may receive (260) the task commencement indication and may generate and transmit (262) a task commencement notification to the remotely accessible server (102). The task commencement notification may include the task identifier, the service provider identifier and the like. Transmission may be via the communication network (120).

The remotely accessible server (102) may receive (264) the task commencement notification from the service provider communication device (104). The remotely accessible server (102) may identify a client associated with the task commencement notification. For example, the remotely accessible server (102) may query the database (110) to identify a client associated with the task identifier. The remotely accessible server (102) may generate and transmit (266) an alert to the client mobile communication device (124) associated with the client. The alert may for example include an estimated time of arrival of the service provider at the predetermined geographical location. Transmission may be via the communication network (120).

The client mobile communication device (124) may receive (268) the alert and may generate and display a notification to the client which alerts the client of the service provider's impending arrival at the predetermined geographical location. The notification may include a redirect input (e.g. in the form of a graphical component such as an icon) which, upon activation, may be configured to cause the remotely accessible server to redirect the service provider to the client's current geographical location, as opposed to the predetermined geographical location.

The client may activate the redirect input which may cause the client mobile communication device (124) to generate and transmit (270) a redirect notification which indicates that the client is not in a position to facilitate completion of the task at the predetermined geographical location. Activating the input may also cause the client mobile communication device (124) to determine its current geographical location, for example using an associated geographical location element, and the notification may include the current geographical location of the client. For example, the client mobile communication device (124) may record the geographical location at which the client mobile communication device (124) is located at the point in time at which the notification is generated and include the geographical location in the notification.

The remotely accessible server (102) may receive (272) the redirect notification from the client mobile communication device (124), which may include receiving the current geographical location from the client mobile communication device. The remotely accessible server (102) may determine (274) whether the current geographical location is within a predetermined range of the predetermined geographical location. The predetermined range may be set so as to represent an acceptable detour. For example, it may be desirable, in order to facilitate completion of the task, to reroute the service provider (114) towards the current location of the client (134). However, this would not make sense if the service provider (114) were to be required to make a significant detour in order to complete the task. The predetermined range may thus be determined based on considerations such as an acceptable maximum detour and may, for example, be in the region of between 1 and 5 kilometers (between 0.6 and 3.1 miles).

If (274) the current geographical location is within the predetermined range of the predetermined geographical location, the remotely accessible server (102) may transmit (276) a redirect instruction to the service provider communication device (104) which may cause the service provider communication device to direct the service provider (114) to the current geographical location of the client (134).

This may include the remotely accessible server (102) polling (278) the client mobile communication device (124) for an updated current geographical location. The client mobile communication device (124) may determine its current geographical location using an associated geographical location element and may respond (280) with its updated current geographical location. The remotely accessible server may receive (282) an updated current geographical location and forward (284) the updated current geographical location to the service provider mobile communication device (104) for use in directing the service provider (114) to the client mobile communication device (124), and hence the client (134).

In some implementations, the remotely accessible server may continue (286) determining whether the updated current geographical location is within the predetermined range to ensure that the client (134) does not cause the service provider to detour significantly. If (274) the distance between the current geographical location of the client and the predetermined geographical location exceeds the predetermined range, the remotely accessible server may transmit a cancellation message to the service provider and client mobile communication devices (104, 124) and may reschedule completion of the task for a later point in time.

The service provider mobile communication device (104) may receive (288) the forwarded current geographical location from the remotely accessible server (102). The service provider mobile communication device (104) may update (290) a navigation component associated therewith with most recent current geographical location of the client so as to direct the service provider towards the client.

Upon reaching the client (134) at the updated current geographical location, the service provider (114) may input the appropriate status ('success' or ‘failure’) and the service provider mobile communication device (104) may receive the input, record the geographical location and associate the status with one or more of the task identifier, the recorded geographical location and a timestamp for the relevant task, as has been described above with reference to FIG. 2.

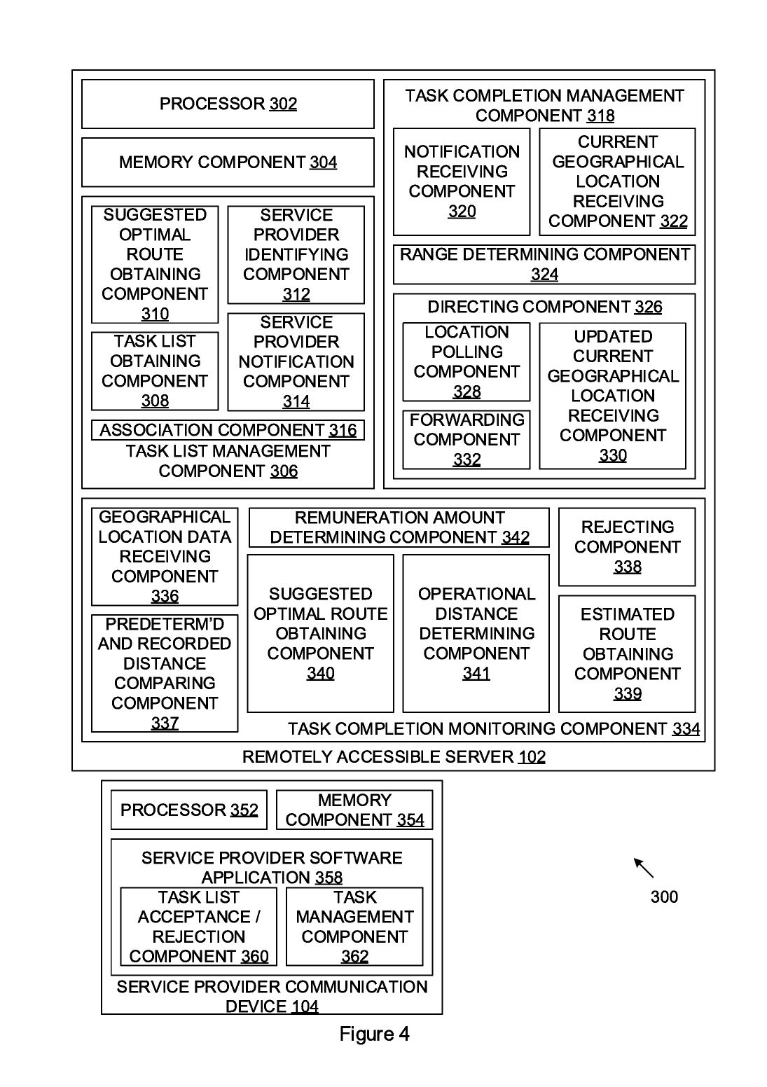

FIG. 4 is a block diagram which illustrates components of an exemplary system (300) for monitoring and managing task completion by an on-demand service provider. The system (300) may include a remotely accessible server (102) and a service provider mobile communication device (104).

The remotely accessible server (102) may include a processor (302) for executing the functions of components described below, which may be provided by hardware or by software units executing on the remotely accessible server (102). The software units may be stored in a memory component (304) and instructions may be provided to the processor (302) to carry out the functionality of the described components.

The remotely accessible server (102) may include a task list management component (306) which may include a task list obtaining component (308) configured to generate or obtain a plurality of task lists. The task list management component (306) may include a suggested optimal route obtaining component (310) configured to obtain a suggested optimal route for each task list based on predetermined geographical locations associated with tasks included in each task list. The task list management component (306) may include a service provider identifying component (312) configured to identify potential service providers (e.g. 114, 116) for each task list. The potential service providers may be best suited to completing or performing the associated tasks. In some implementations, the suggested optimal route obtaining component (310) may be configured to obtain a suggested optimal route for a partially complete task list in response to receiving a request from an associated service provider to do so.

The task list management component (306) may include a service provider notification component (314) configured to transmit an offer notification to the communication devices (104, 106) of the identified service providers (114, 116). The offer notification may include the task list and may be configured to prompt the service provider (114, 116) for his or her acceptance or rejection of the task list. The service provider notification component (314) may be configured to receive the identified service providers' (114, 116) acceptance or rejection of the task list, as the case may be. The task list management component (306) may include an association component (316) configured to associate a service provider (114) from whom an acceptance notification is received with the relevant task list.

The remotely accessible server (102) may include a task completion management component (318) which may be configured to re-route service providers to updated current locations upon receiving a notification from client mobile communication device (e.g. 124) to the effect that the client is no longer at the predetermined geographical location.

The task completion management component (318) may include a notification receiving component (320) arranged to receive a notification from a mobile communication device associated with a client in respect of whom a task relates. The notification may indicate that the client is not in a position to facilitate completion of the task at the predetermined geographical location associated therewith. The task completion management component (318) may also include a current geographical location receiving component (322) arranged to receive a current geographical location from the client mobile communication device and a range determining component (324) arranged to determine whether the current geographical location is within a predetermined range of the predetermined geographical location. The task completion management component (318) may also include a directing component (326) arranged to direct the service provider to the current geographical location if the current geographical location is within the predetermined range of the predetermined geographical location.

The directing component (326) may include a location polling component (328) arranged to poll the client mobile communication device for an updated current geographical location. Polling the client mobile communication device may include periodically requesting an updated geographical location from the client mobile communication device. The directing component (326) may also include an updated current geographical location receiving component (330) configured to receive an updated current geographical location from the client mobile communication device. The updated current geographical location may be received in response to the remotely accessible server polling the client mobile communication device. Alternatively, the client mobile communication device may continue to transmit an updated current geographical location in response to receiving an appropriate request from the remotely accessible server (102). The directing component (326) may include a forwarding component (332) arranged to forward the updated current geographical location to the service provider mobile communication device (104) for use by the service provider mobile communication device (104) in directing the service provider (114) to the client mobile communication device (124).

The remotely accessible server (102) may include a task completion monitoring component (334). The task completion monitoring component (334) may include a geographical location data receiving component (336) arranged to receive geographical location data from the service provider mobile communication devices. The geographical location data may represent a sequence of recorded geographical locations, each of which corresponds to a predetermined geographical location and representing a location at which the relevant service provider purports to have attempted to complete an associated task. The geographical location data may include a status, task identifier and timestamp associated with each recorded geographical location.

The task completion monitoring component (334) may include a predetermined and recorded distance comparing component (337) arranged to determine a distance between each recorded geographical location associated with a failure status and the associated predetermined geographical location. The task completion monitoring component (334) may include a rejecting component (338) arranged to reject the recorded geographical location and associated status. This may include excluding the recorded geographical location from the estimated route.

The task completion monitoring component (334) may include an estimated route obtaining component (339) arranged to obtain an estimated route using the sequence of recorded geographical location data. The estimated route may represent a probable route having been traversed by the relevant service provider in attempting to complete the plurality of tasks in sequence. The task completion monitoring component (334) may include a suggested optimal route accessing component (340) arranged to access the suggested optimal route associated with the estimated route and/or received geographical location data.

The task completion monitoring component (334) may include an operational distance determining component (341) which may be configured to determine an operational distance based on a total distance of the estimated route and on a total distance of the suggested optimal route. This may include determining an average of the estimated and suggested optimal route distances.

The remotely accessible server (102) may include a remuneration amount determining component (342) arranged to determine a remuneration amount payable to the service provider for completing the plurality of tasks. The remuneration amount may be determined based on the operational distance and the status associated with each recorded geographical location. In some implementations, the remuneration amount may be determined as the sum of the operational distance multiplied by a distance-based amount and the number of success statuses multiplied by a success-based amount.

The service provider device (104) may include may include a processor (352) for executing the functions of components described below, which may be provided by hardware or by software units executing on the service provider device (104). The software units may be stored in a memory component (354) and instructions may be provided to the processor (352) to carry out the functionality of the described components. Some or all of the components may be provided by a service provider software application (358) downloadable onto and executable on the service provider device (104).

The software application (358) may include a task list acceptance/rejection component (360) which may be configured to receive a task list from the remotely accessible server (102) for acceptance or rejection. The task list acceptance/rejection component (360) may be configured to prompt the associated service provider for his or her acceptance or rejection of the task list. The prompt may include a visual and audible notification. This may include displaying particulars of the task list, for example the number of tasks, the estimated total distance, timing constraints, etc. The acceptance/rejection component (360) may be configured to receive user input indicating an acceptance or rejection, as the case may be, of the task list and to transmit an appropriate acceptance or rejection notification to the remotely accessible server (102).

The software application (358) may include a task completion monitoring component (362). The task completion monitoring component (362) may be configured to receive user input indicating either a success or failure in respect of a task in an accepted task list. The success or failure may indicate either a successful or unsuccessful completion or performance of the associated task. In response to receiving the user input, the task completion monitoring component (362) may be configured to record the geographical location of the service provider device (104). This may include obtaining real-time geographical information from a geographical location element embedded within the service provider device (104). The task completion monitoring component (362) may be configured to associate a success or failure status, as the case may be, with one or more of the task identifier, the recorded geographical location and a timestamp. The task completion monitoring component (362) may be configured to transmit geographical location data including the status, task identifier, recorded geographical location and timestamp to the remotely accessible server (102). In some cases, the task completion monitoring component (362) may transmit the status, task identifier, recorded geographical location and timestamp to the remotely accessible server in real-time (e.g. in response to associating the data) such that the remotely accessible server (102) receives the geographical location data through the course of the day, etc., or alternatively as a batch together with other statuses and associated data, for example once the task list has been completed.

The described system and method may accordingly enable recording of service provider's mobile phone's location using GPS when the service provider records a failed delivery and subsequent use of this information to remunerate the service provider if he or she eventually successfully delivers completes the relevant task (and if he or she was within a threshold distance of the delivery location when he or she recorded the failure). A “delivery to phone” functionality may also be provided if the client indicates that he or she is no longer in a position to facilitate completion of a task and his or her phone's location indicates that he or she is still within a threshold distance (e.g. 2 km, 5 km, etc.) of home.

FIG. 5 illustrates an example of a computing device (500) in which various aspects of the disclosure may be implemented. The computing device (500) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (500) may be suitable for storing and executing computer program code. The various participants and elements in the previously described system diagrams may use any suitable number of subsystems or components of the computing device (500) to facilitate the functions described herein. The computing device (500) may include subsystems or components interconnected via a communication infrastructure (505) (for example, a communications bus, a network, etc.). The computing device (500) may include one or more processors (510) and at least one memory component in the form of computer-readable media. The one or more processors (510) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (500) may be distributed over a number of physical locations (e.g. in a distributed, cluster or cloud-based computing configuration) and appropriate software units may be arranged to manage and/or process data on behalf of remote devices.

The memory components may include system memory (515), which may include read only memory (ROM) and random access memory (RAM). A basic input/output system (BIOS) may be stored in ROM. System software may be stored in the system memory (515) including operating system software. The memory components may also include secondary memory (520). The secondary memory (520) may include a fixed disk (521), such as a hard disk drive, and, optionally, one or more storage interfaces (522) for interfacing with storage components (523), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (500) may include an external communications interface (530) for operation of the computing device (500) in a networked environment enabling transfer of data between multiple computing devices (500) and/or the Internet. Data transferred via the external communications interface (530) may be in the form of signals, which may be electronic, electromagnetic, optical, radio, or other types of signal. The external communications interface (530) may enable communication of data between the computing device (500) and other computing devices including servers and external storage facilities. Web services may be accessible by and/or from the computing device (500) via the communications interface (530).

The external communications interface (530) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry. The external communications interface (530) may include a subscriber identity module (SIM) in the form of an integrated circuit that stores an international mobile subscriber identity and the related key used to identify and authenticate a subscriber using the computing device (500). One or more subscriber identity modules may be removable from or embedded in the computing device (500).

The external communications interface (530) may further include a contactless element (550), which is typically implemented in the form of a semiconductor chip (or other data storage element) with an associated wireless transfer element, such as an antenna. The contactless element (550) may be associated with (e.g., embedded within) the computing device (500) and data or control instructions transmitted via a cellular network may be applied to the contactless element (550) by means of a contactless element interface (not shown). The contactless element interface may function to permit the exchange of data and/or control instructions between computing device circuitry (and hence the cellular network) and the contactless element (550). The contactless element (550) may be capable of transferring and receiving data using a near field communications capability (or near field communications medium) typically in accordance with a standardized protocol or data transfer mechanism (e.g., ISO 14443/NFC). Near field communications capability may include a short-range communications capability, such as radio-frequency identification (RFID), Bluetooth™, infra-red, or other data transfer capability that can be used to exchange data between the computing device (500) and an interrogation device. Thus, the computing device (500) may be capable of communicating and transferring data and/or control instructions via both a cellular network and near field communications capability.

The computer-readable media in the form of the various memory components may provide storage of computer-executable instructions, data structures, program modules, software units and other data. A computer program product may be provided by a computer-readable medium having stored computer-readable program code executable by the central processor (510). A computer program product may be provided by a non-transient computer-readable medium or may be provided via a signal or other transient means via the communications interface (530). Interconnection via the communication infrastructure (505) allows the one or more processors (510) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (500) either directly or via an I/O controller (535). One or more displays (545) (which may be touch-sensitive displays) may be coupled to or integrally formed with the computing device (500) via a display (545) or video adapter (540).

The computing device (500) may include a geographical location element (555) which is arranged to determine the geographical location of the computing device (500). The geographical location element (555) may for example be implemented by way of a global positioning system (GPS), or similar, receiver module. In some implementations the geographical location element (555) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (500). In some implementations, the geographical location element (555) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques.

The computer program code may be stored as a series of instructions, or commands on a non-transitory computer-readable medium, such as a random-access memory (RAM), a read-only memory (ROM), a magnetic medium such as a hard-drive, or an optical medium such as a CD-ROM. Any such computer-readable medium may also reside on or within a single computational apparatus and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method comprising:
receiving geographical location data from a mobile communication device associated with a service provider, the geographical location data representing a sequence of recorded geographical locations, each of the recorded geographical locations representing a location at which a service provider inputs a task completion status into the mobile communication device in association with a task and associated predetermined geographical location;
obtaining an estimated route using the sequence of recorded geographical locations, the estimated route representing a probable route having been traversed by the service provider in attempting to complete the tasks;
accessing a suggested optimal route, the suggested optimal route being based on the predetermined geographical locations and representing an optimal route for completing the tasks in an optimal sequence; and,
determining an operational distance based on a total distance of the estimated route and on a total distance of the suggested optimal route.

2. The method as claimed in claim 1, including:
providing an application to the service provider for installation on the mobile communication device;
storing the geographical location data in a database in association with a task list; and
outputting the operational distance.

3. The method of claim 1, wherein the optimal route and estimated route are different.

4. The method of claim 1, wherein the optimal route is based on an optimal sequence of the predetermined geographical locations and wherein the estimated route is based on the actual sequence of the recorded geographical locations.

5. The method of claim 1, wherein each recorded geographical location is recorded by a geographical location element of the mobile communication device associated with the service provider.

6. The method of claim 5, wherein each recorded geographical location is recorded responsive to the service provider inputting into the mobile communication device the task completion status, being one of a success or failure status in respect of an attempted completion of the task.

7. The method of claim 1, wherein the geographical location data includes, for each recorded geographical location, one or more of: the task completion status, a task identifier associated with the task and a timestamp at which the geographical location is recorded.

8. The method of claim 7, including determining a distance between each recorded geographical location associated with a failure status and the corresponding predetermined geographical location and, if the distance is greater than a predetermined threshold, rejecting the recorded geographical location and associated status.

9. The method of claim 8, wherein rejecting the recorded geographical location and associated status excludes the recorded geographical location from the estimated route.

10. The method of claim 1, including:
receiving a notification from a mobile communication device associated with a client in respect of whom a task relates, the notification indicating that the client is not in a position to facilitate completion of the task at the predetermined geographical location associated therewith;
receiving a current geographical location from the client mobile communication device;
determining whether the current geographical location is within a predetermined range of the predetermined geographical location; and,
if the current geographical location is within the predetermined range of the predetermined geographical location, directing the service provider to the current geographical location.

11. The method of claim 10, wherein directing the service provider to the current geographical location includes:
polling the client mobile communication device for an updated current geographical location;
receiving an updated current geographical location from the client mobile communication device; and,
forwarding the updated current geographical location to the service provider mobile communication device for use in directing the service provider to the client mobile communication device.

12. A system comprising:
a processor and a memory configured to provide computer program instructions to the processor to execute functions of components;
a geographical location data receiving component for receiving geographical location data from a mobile communication device associated with a service provider, the geographical location data representing a sequence of recorded geographical locations, each of the recorded geographical locations representing a location at which a service provider inputs a task completion status into the mobile communication device in association with a task and associated predetermined geographical location;
an estimated route obtaining component for obtaining an estimated route using the sequence of recorded geographical locations, the estimated route representing a probable route having been traversed by the service provider in attempting to complete the tasks in sequence;
a suggested optimal route obtaining component for accessing a suggested optimal route, the suggested optimal route being based on the predetermined geographical locations and representing an optimal route for completing the tasks in an optimal sequence; and,
an operational distance determining component for determining an operational distance based on a total distance of the estimated route and on a total distance of the suggested optimal route.

13. The system of claim 12, wherein each recorded geographical location is recorded by a geographical location element of the mobile communication device associated with the service provider.

14. The system of claim 12, wherein each recorded geographical location is recorded responsive to the service provider inputting into the mobile communication device the task completion status, being one of a success or failure status in respect of an attempted completion of the task.

15. The system of claim 12, wherein the geographical location data includes, for each recorded geographical location, one or more of: the task completion status, a task identifier associated with the task and a timestamp at which the geographical location is recorded.

16. The system of claim 15, including a predetermined and recorded distance comparing component for determining a distance between each recorded geographical location associated with a failure status and the corresponding predetermined geographical location and a rejecting component for, if the distance is greater than a predetermined threshold, rejecting the recorded geographical location and associated status.

17. The system of claim 16, wherein the rejecting component excludes the recorded geographical location from the estimated route.

18. The system of claim 12, including:
a notification receiving component for receiving a notification from a mobile communication device associated with a client in respect of whom a task relates, the notification indicating that the client is not in a position to facilitate completion of the task at the predetermined geographical location associated therewith;
a current geographical location receiving component for receiving a current geographical location from the client mobile communication device;
a range determining component for determining whether the current geographical location is within a predetermined range of the predetermined geographical location; and,
a directing component for, if the current geographical location is within the predetermined range of the predetermined geographical location, directing the service provider to the current geographical location.

19. The system of claim 18, wherein the directing component includes:
a location polling component for polling the client mobile communication device for an updated current geographical location;
an updated current geographical location receiving component for receiving an updated current geographical location from the client mobile communication device; and,
a forwarding component for forwarding the updated current geographical location to the service provider mobile communication device for use in directing the service provider to the client mobile communication device.

20. A computer program product comprising a computer-readable medium having stored computer-readable program code for performing the steps of:
receiving geographical location data from a mobile communication device associated with a service provider, the geographical location data representing a sequence of recorded geographical locations, each of the recorded geographical locations representing a location at which a service provider inputs a task completion status into the mobile communication device in association with a task and associated predetermined geographical location;
obtaining an estimated route using the sequence of recorded geographical locations, the estimated route representing a probable route having been traversed by the service provider in attempting to complete the tasks;
accessing a suggested optimal route, the suggested optimal route being based on the predetermined geographical locations and representing an optimal route for completing the tasks in an optimal sequence; and,
determining an operational distance based on a total distance of the estimated route and on a total distance of the suggested optimal route.
